(19) United States
(12) Patent Application Publication
(10) Pub. No.: US 2024/0399481 A1
(43) Pub. Date: Dec. 5, 2024

(54) WAVEFORM CONTROL AND ADAPTIVE COMPENSATION METHOD FOR PULSED GAS SHIELDED WELDING

(71) Applicant: WeldMart Inc., Charleston, SC (US)

(72) Inventor: Xiaofeng YE, wenzhou (CN)

(21) Appl. No.: 18/799,976

(22) Filed: Aug. 9, 2024

(51) Int. Cl. B23K 9/09; B23K 9/095

(52) U.S. Cl. CPC B23K 9/09; B23K 9/0953

(57) ABSTRACT

Provided is a waveform control and adaptive compensation method for pulsed gas shielded welding, which comprises the following steps: step 1: acquiring an actual welding pulse waveform at an initial welding stage; step 2: according to the actual welding pulse waveform, extracting initial parameter values of the pulse waveform and an actually output pulse peak voltage Us at the beginning of welding; step 3: judging whether the actually output pulse peak voltage Us is abnormal; and step 4: when the actually output pulse peak voltage Us is abnormal, forming new parameter values of the pulse waveform for pulse waveform compensation. According to the waveform control and adaptive compensation method for pulsed gas shielded welding, an influence of environment on globular transfer can be effectively reduced through pulse control and pulse waveform compensation, thus improving an anti-interference performance and ensuring a welding effect.

### TECHNICAL FIELD

The present invention relates to the technical field of welding, and particularly to a waveform control and adaptive compensation method for pulsed gas shielded welding.

### BACKGROUND OF THE PRESENT INVENTION

With the rapid development of welding technology today, the application of gas metal arc welding has become more and more common and extensive, and a welding technology based on the gas metal arc welding has emerged one after another.

As one of the commonly used welding methods, the gas metal arc welding has the following advantages: \textcircled{1} high efficiency and fast welding speed; \textcircled{2} large penetration and small welding deformation; \textcircled{3} welding in various positions and strong flexibility; and \textcircled{4} open arc operation, and convenience for observation of weld pool and electric arc. On the premise of wide application of the gas metal arc welding, people put forward higher requirements for welding speed, welding quality and the like, and pulsed gas shielded welding came into being. The pulsed gas shielded welding has the advantages that the traditional gas metal arc welding does not have, and has a more stable welding process, less spatter and less material loss. In a production process, welders may weld workpieces manually or by using a robot. However, in welding production, an unstable phenomenon will sometimes appear in a process of pulse welding due to influences of field working conditions and base metal.

How to improve the adaptability of pulse welding to the external environment and reduce the influence of manual work on welding is a major welding project of the pulsed gas shielded welding. Generally, changes of arc length and welding speed during manual welding and a change of welding angle caused by gesture change during welding swing will all affect a globular transfer mode, thus affecting weld formation and even causing welding defects. Therefore, a new waveform control and adaptive compensation method for pulsed gas shielded welding is invented.

### SUMMARY OF THE PRESENT INVENTION

The object of the present invention is to provide a waveform control and adaptive compensation method for pulsed gas shielded welding which can effectively reduce an influence on welding through pulse control and pulse waveform compensation.

The object of the present invention can be achieved by the following technical measure: a waveform control and adaptive compensation method for pulsed gas shielded welding is provided, wherein the waveform control and adaptive compensation method for pulsed gas shielded welding comprises the following steps:
step 1: acquiring an actual welding pulse waveform at an initial welding stage;
step 2: according to the actual welding pulse waveform, extracting initial parameter values of the pulse waveform and an actually output pulse peak voltage Us at the beginning of welding;
step 3: judging whether the actually output pulse peak voltage Us is abnormal; and
step 4: when the actually output pulse peak voltage Us is abnormal, forming new parameter values of the pulse waveform for pulse waveform compensation.

The object of the present invention can also be achieved by the following technical measure.

In the step 1, a voltage and a current at peak stages are collected at the initial welding stage to acquire the actual welding pulse waveform.

In the step 2, the extracted initial parameter values of the pulse waveform comprise an average voltage at a peak stage, a voltage at a base stage, first pulse falling time L1 and a pulse peak current I1.

In the step 3, the occurrence of abnormality is judged by comparing the actually output pulse peak voltage Us with an abnormality determination voltage Ua; and when the pulse peak voltage Us is abnormal, the procedure goes to the step 4, and when the pulse peak voltage Us is not abnormal, the procedure returns to the step 1.

In the step 3, the abnormality determination voltage Ua is a range value, and comprises an upper limit voltage Ua1 and a lower limit voltage Ua2, and the Ua1 is greater than the Ua2.

In the step 3, the occurrence of abnormal voltage is judged by comparing the actually output pulse peak voltage Us with the abnormality determination voltages Ua1 and Ua2; and when the actually output pulse peak voltage Us is greater than or equal to the abnormality determination voltage Ua1, or when the actually output pulse peak voltage Us is less than or equal to the abnormality determination voltage Ua2, globular transfer is judged to be abnormal.

In the step 4, when the pulse peak voltage Us is abnormal, the new parameter values of the pulse waveform are calculated through the Us and the Ua, and the new parameter values of the pulse waveform are formed for pulse waveform compensation.

In the step 4, the new parameter values of the pulse waveform are formed for pulse waveform compensation by formulas:

$$I 1 = \vert Us - Ua \vert * K 1 + A \\ L 1 = \vert Us - Ua \vert * K 2 + T$$

wherein, L1 is first pulse falling time;
I1 is a pulse peak current;
K1 is a proportion coefficient, >=0;
K2 is a proportion coefficient, >=0; and
A and T are coefficients.

In the step 4, after the globular transfer is judged to be abnormal, the pulse waveform is compensated after a next pulse period, whether the globular transfer is abnormal is judged again until the globular transfer is judged to be no longer abnormal, the compensation process of the pulse waveform is ended, and the waveform before compensation is restored.

In the step 4, when the pulse waveform is compensated through the new parameter values of the pulse waveform, the pulse waveform is compensated through L1′ and I1′; and a peak current of a next period is increased, electric arc energy is enhanced to form globules, and a falling slope of the current is changed at the same time, so that the globules are ejected at a middle stage of a falling process, thus avoiding the occurrence of short circuit at the base stage.

According to the waveform control and adaptive compensation method for pulsed gas shielded welding in the present invention, a preset waveform is compared with an actual welding waveform to judge whether the globular transfer is abnormal, and a compensation amount is calculated after the occurrence of abnormality to generate a new welding waveform, so as to make the globular transfer normal. According to the present invention, an influence of environment on the globular transfer can be effectively reduced through pulse control and pulse waveform compensation, thus improving an anti-interference performance and ensuring a welding effect.

### DESCRIPTION OF THE DRAWINGS

FIG. 1 is a schematic diagram of a pulse waveform in one specific embodiment of the present invention.

FIG. 2 is a flow chart of one specific embodiment of a waveform control and adaptive compensation method for pulsed gas shielded welding according to the present invention.

### DETAILED DESCRIPTION OF PREFERRED EMBODIMENTS

It should be noted that the following detailed descriptions are all exemplary and are intended to further describe the present invention. Unless otherwise specified, all technical and scientific terms used herein have the same meanings as those commonly understood by those of ordinary skills in the art to which the present invention belongs.

It should be noted that the terms used herein are only used to describe specific embodiments, and are not intended to limit exemplary embodiment according to the present invention. As used herein, the singular form is intended to include the plural form, unless the context clearly indicates otherwise. In addition, it should be further understood that terms “include” and/or “comprise” used in this specification indicate that there are features, steps, operations, and/or combinations thereof.

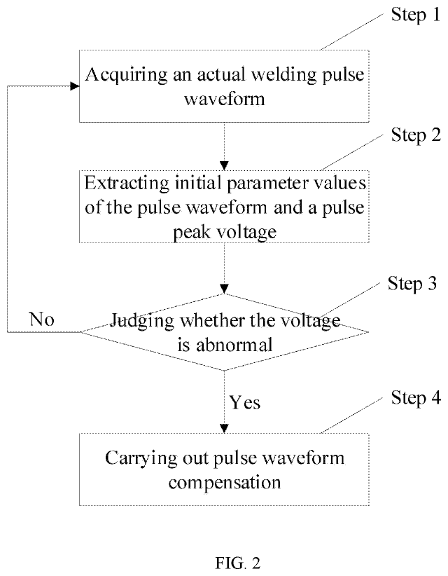

As shown in FIG. 2, FIG. 2 is a flow chart of a waveform control and adaptive compensation method for pulsed gas shielded welding according to the present invention. The waveform control and adaptive compensation method for pulsed gas shielded welding comprises the following steps.

In step 1, an actual welding pulse waveform is acquired at an initial welding stage.

A voltage and a current at peak stages are collected at the initial welding stage to acquire the actual welding pulse waveform.

In step 2, according to the actual welding pulse waveform, initial parameter values of the pulse waveform and an actually output pulse peak voltage Us are extracted at the beginning of welding.

The initial parameter values of the pulse waveform comprise an average voltage at a peak stage, a voltage at a base stage, first pulse falling time L1 and a pulse peak current I1.

In step 3, the occurrence of abnormality is judged by comparing the actually output pulse peak voltage Us with an abnormality determination voltage Ua; and when the pulse peak voltage Us is abnormal, the procedure goes to the step 4, and when the pulse peak voltage Us is not abnormal, the procedure returns to the step 1.

The abnormality determination voltage Ua is a range value, and comprises an upper limit voltage Ua1 and a lower limit voltage Ua2. The occurrence of abnormal voltage is judged by comparing the actually output pulse peak voltage Us with the abnormality determination voltages Ua1 and Ua2. When the actually output pulse peak voltage Us is greater than or equal to the abnormality determination voltage Ua1, or when the actually output pulse peak voltage Us is less than or equal to the abnormality determination voltage Ua2, globular transfer is judged to be abnormal.

In step 4, when the voltage is abnormal, the new parameter values of the pulse waveform are calculated through the Us and the Ua, and the new parameter values of the pulse waveform are formed for pulse waveform compensation.

$$I 1 = \vert Us - Ua \vert * K 1 + A$$

K1 is a proportion coefficient, >=0.

$$L 1 = \vert Us - Ua \vert * K 2 + T$$

K2 is a proportion coefficient, >=0.

Specifically, when the globular transfer is judged to be normal, the pulse waveform is not compensated. After the globular transfer is judged to be abnormal, the pulse waveform is compensated after a next pulse period, whether the globular transfer is abnormal is judged again until the globular transfer is judged to be no longer abnormal, the compensation process of the pulse waveform is ended, and the waveform before compensation is restored.

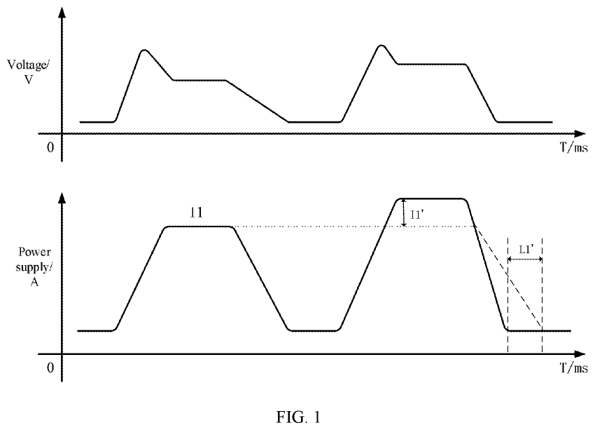

As shown in FIG. 1, when the pulse waveform is compensated through the new parameter values of the pulse waveform, the pulse waveform is compensated through L1′ and I1′. A peak current of a next period is increased, electric arc energy is enhanced to form globules, and a falling slope of the current is changed at the same time, so that the globules are ejected at a middle stage of a falling process, thus avoiding the occurrence of short circuit at the base stage.

In one embodiment, a peak voltage at a pulse stage of the welding waveform is acquired as the abnormality determination voltage Ua at the initial welding stage, and an average voltage Us at a peak stage of each pulse period is calculated at a subsequent welding stage.

There are a total of three situations.

1) If the Us is greater than or equal to the abnormality determination voltage Ua1, the globular transfer is judged to be abnormal.

2) If the Us is less than the abnormality determination voltage Ua2, the globular transfer is judged to be abnormal.

3) If Ua1>U>Ua2, the globular transfer is judged to be normal.

In one specific embodiment of the present invention, the waveform control and adaptive compensation method for pulsed gas shielded welding comprises the following steps.

After successful arc striking, the procedure goes to a welding stage, and an average voltage Ua at a peak stage of several consecutive pulse waveforms is recorded to generate the upper limit value of the abnormal voltage Ua1=Ua+b and the lower limit value of abnormal voltage Ua2=Ua−b, wherein b is an allowable value of voltage fluctuation, which is usually 0 to 2.0 V.

After welding, the average voltage Us at the peak stage of each pulse waveform is calculated. Us>Ua1 and Ua2>Us are both regarded as abnormal transfer, and a time compensation amount L1′ for gradual falling from the peak stage to the base stage and a current compensation amount I1′ at the peak stage are generated. The L1′ is less than 0, and the I1′ is greater than 0.

The L1′ and the I1′ are applied to the next period, the average voltage Us at the peak stage is calculated, and compared with the Ua1 and the Ua2 to judge whether the abnormality occurs, and a new compensation amount is generated.

The pulse waveform compensation and the increase of pulse stiffness and pulse transfer energy can both ensure a stable one-pulse one-globule transfer state, so that an electric arc always maintains good stability throughout the welding process.

Finally, it should be noted that: the above are only the preferred embodiments of the present invention, and the preferred embodiments are not intended to limit the present invention. Although the present invention is described in detail with reference to the above embodiments, those skilled in the art may still modify the technical solutions recorded in the above embodiments, or make equivalent replacements to some of the technical features. Any modification, equivalent substitution, improvement, etc. made within the spirit and principle of the present invention are included in the scope of protection of the present invention.

Except for the technical features described in the specification, they are all known to those skilled in the art.

We claim:

1. A waveform control and adaptive compensation method for pulsed gas shielded welding, wherein the waveform control and adaptive compensation method for pulsed gas shielded welding comprises the following steps:
step 1: acquiring an actual welding pulse waveform at an initial welding stage;
step 2: according to the actual welding pulse waveform, extracting initial parameter values of the pulse waveform and an actually output pulse peak voltage Us at the beginning of welding;
step 3: judging whether the actually output pulse peak voltage Us is abnormal; and
step 4: when the actually output pulse peak voltage Us is abnormal, forming new parameter values of the pulse waveform for pulse waveform compensation.

2. The waveform control and adaptive compensation method for pulsed gas shielded welding according to claim 1, wherein, in the step 1, a voltage and a current at peak stages are collected at the initial welding stage to acquire the actual welding pulse waveform.

3. The waveform control and adaptive compensation method for pulsed gas shielded welding according to claim 1, wherein, in the step 2, the extracted initial parameter values of the pulse waveform comprise an average voltage at a peak stage, a voltage at a base stage, first pulse falling time L1 and a pulse peak current I1.

4. The waveform control and adaptive compensation method for pulsed gas shielded welding according to claim 1, wherein, in the step 3, the occurrence of abnormality is judged by comparing the actually output pulse peak voltage Us with an abnormality determination voltage Ua; and when the pulse peak voltage Us is abnormal, the procedure goes to the step 4, and when the pulse peak voltage Us is not abnormal, the procedure returns to the step 1.

5. The waveform control and adaptive compensation method for pulsed gas shielded welding according to claim 4, wherein, in the step 3, the abnormality determination voltage Ua is a range value, and comprises an upper limit voltage Ua1 and a lower limit voltage Ua2, and the Ua1 is greater than the Ua2.

6. The waveform control and adaptive compensation method for pulsed gas shielded welding according to claim 5, wherein, in the step 3, the occurrence of abnormal voltage is judged by comparing the actually output pulse peak voltage Us with the abnormality determination voltages Ua1 and Ua2; and when the actually output pulse peak voltage Us is greater than or equal to the abnormality determination voltage Ua1, or when the actually output pulse peak voltage Us is less than or equal to the abnormality determination voltage Ua2, globular transfer is judged to be abnormal.

7. The waveform control and adaptive compensation method for pulsed gas shielded welding according to claim 6, wherein, in the step 4, when the pulse peak voltage Us is abnormal, the new parameter values of the pulse waveform are calculated through the Us and the Ua, and the new parameter values of the pulse waveform are formed for pulse waveform compensation.

8. The waveform control and adaptive compensation method for pulsed gas shielded welding according to claim 7, wherein, in the step 4, the new parameter values of the pulse waveform are formed for pulse waveform compensation by formulas:
$$I 1 = \vert Us - Ua \vert * K 1 + A \\ L 1 = \vert Us - Ua \vert * K 2 + T$$
wherein, L1 is first pulse falling time;
I1 is a pulse peak current;
K1 is a proportion coefficient, >=0;
K2 is a proportion coefficient, >=0; and
A and T are coefficients.

9. The waveform control and adaptive compensation method for pulsed gas shielded welding according to claim 8, wherein, in the step 4, after the globular transfer is judged to be abnormal, the pulse waveform is compensated after a next pulse period, whether the globular transfer is abnormal is judged again until the globular transfer is judged to be no longer abnormal, the compensation process of the pulse waveform is ended, and the waveform before compensation is restored.

10. The waveform control and adaptive compensation method for pulsed gas shielded welding according to claim 9, wherein, in the step 4, when the pulse waveform is compensated through the new parameter values of the pulse waveform, the pulse waveform is compensated through L1′ and I1′; and a peak current of a next period is increased, electric arc energy is enhanced to form globules, and a falling slope of the current is changed at the same time, so that the globules are ejected at a middle stage of a falling process, thus avoiding the occurrence of short circuit at the base stage.
